(19) United States
(12) Patent Application Publication
(10) Pub. No.: US 2026/0296150 A1
(43) Pub. Date: Oct. 1, 2026

(54) Removable Door for Sport Utility Vehicle

(71) Applicant: Peter MacIntyre, Hingham, MA (US)

(72) Inventor: Peter MacIntyre, Hingham, MA (US)

(21) Appl. No.: 19/631,222

(22) Filed: Mar. 27, 2026

Related U.S. Application Data
(60) Provisional application No. 63/778,638, filed on Mar. 27, 2025.

(51) Int. Cl. B60J 5/04; B60J 1/08

(52) U.S. Cl. CPC B60J 5/0487; B60J 1/085; B60J 5/048

(57) ABSTRACT

A removable door for a sport utility vehicle (SUV) having a rigid perimeter frame that carries two hinge pins on the front side that are configured to be engaged with door hinges of the SUV, and a door latch on the rear side that is configured to engage with a door latch of the SUV, an annular rim canvas that is configured to fit over and cover the frame, with openings for the hinge pins and a zipper along its interior that defines a door opening, a flexible door insert with an external zipper that matches and is configured to be coupled to the rim canvas zipper, to removably close the door opening, wherein the door insert includes a clear flexible window element, and a closable flap in the door insert that is configured to be opened from outside the door to allow a person to reach through the door and operate the door latch, to allow the door to be opened from the outside.

### CROSS-REFERENCE TO RELATED APPLICATION

This application claims priority of Provisional Patent Application 63/778,638, filed on Mar. 27, 2025. The disclosure of this priority application is incorporated by reference herein, for all purposes.

### BACKGROUND OF THE INVENTION

Doors for sport utility vehicles (SUVs) are sometimes designed to be removable, but when removed they can be difficult to store.

### SUMMARY OF THE INVENTION

Disclosed herein is a removable door for a sport utility vehicle (SUV). The door is made from a rigid perimeter frame. A rim piece (which may be made from canvas or another flexible material) is attached to the frame and carries a zipper. In an example the rim piece covers at least most of the frame. An insert can be zipped into and out of the canvas rim. The insert is made of canvas and includes a flexible transparent window member. Both sides can include a temporary support member that can be engaged with the insert to carry the weight of the insert when it is partially unzipped (from the top), so that air can enter/leave the vehicle interior and also to allow a person to reach through the door (e.g., at a fast-food restaurant pickup window). The insert can also include a small flap attached to the canvas with a hook and loop fastener or the like, where the flap can be opened to allow a user to reach through the door and operate the door latch. The door latch operating handle can be extended with a flexible pigtail, so it is easier to grasp and operate when a person reaches through the flap from the outside. The door can thus remain on the vehicle but when the insert is removed it provides outside access similar to when the door has been removed in a traditional SUV.

In one aspect a removable door for an SUV includes a rigid perimeter frame that carries two hinge pins on the front side that are configured to be engaged with door hinges of the SUV, and a door latch on the rear side that is configured to engage with a door latch of the SUV. An annular rim canvas fits over and covers the frame, with openings for the hinge pins and a zipper along its interior that defines a door opening. A flexible door insert has an external zipper that matches and is configured to be coupled to the rim canvas zipper, to removably close the door opening. The door insert includes a clear flexible window element. There is a closable flap in the door insert that is configured to be opened from outside the door to allow a person to reach through the door and operate the door latch, to allow the door to be opened from the outside.

In an example the hinge pins include stops that limit the insertion of the hinge pins into the door hinges of the SUV. In an example the flap is coupled to the door insert in part by sewing. In an example the flap is coupled to the door insert in further part by a hook and loop fastener system.

In an example the removable door also includes removable supports for the door insert. In an example the removable supports for the door insert comprise at least one piece of support material that is coupled to the rim canvas and can be selectively coupled to the door insert. In an example the support material comprises webbing. In an example the support material is coupled to the rim canvas in such a way that it can be pulled across the zipper and be coupled to the door insert. In an example the support material is configured to be coupled to the door insert by a snap. In an example the removable door has two removable door insert supports, one in the front and one in the rear, to support the door insert when it has been partially unzipped from the rim canvas at the top.

In an example the removable door also includes an elongated pocket attached to the inside of the door insert. In an example the removable door also includes a strip of solid material that is configured to removably fit into the elongated pocket, so that the door is more stable in high winds. In an example the strip of solid material comprises a batten.

### BRIEF DESCRIPTION OF DRAWINGS

FIG. 1 is a side view of an SUV with a removable door of the invention.

FIG. 2A is an exterior view of a door frame and FIG. 2B is an interior view thereof.

FIG. 3 illustrates the canvas rim mounted on the door frame.

FIG. 4 illustrates the door insert partially coupled to the canvas rim.

FIG. 5 illustrates the door insert fully coupled to the canvas rim.

FIG. 6 illustrates an interior view of the door insert showing the doggy door.

FIG. 7A illustrates the snapped-on webbing that supports the weight of the open window, in the window closed position.

FIG. 7B illustrates the snapped-on webbing that supports the weight of the open window, in the deployed, window open position.

FIG. 8 illustrates an example of a latch assembly.

FIG. 9 illustrates a batten in place in a pocket of the door insert.

FIG. 10 illustrates a door with a batten.

FIG. 11 illustrates a door insert being rolled up for storage.

FIG. 12 illustrates the door insert stored in a storage bag.

### DETAILED DESCRIPTION OF THE INVENTION

Disclosed herein is a removable door for a sport utility vehicle (SUV). The door is made from a rigid perimeter frame. A rim piece made of flexible material is attached to the frame and carries a zipper. In an example the rim piece covers at least most of the frame. An insert can be zipped into and out of the canvas rim. The insert is made of canvas and includes a flexible transparent window member. Both sides can include a temporary support member that can be engaged with the insert to carry the weight of the insert when it is partially unzipped (from the top), so that air can enter/leave the vehicle interior and also to allow a person to reach through the door (e.g., at a fast food restaurant pickup window). The insert can also include a small flap attached to the canvas with a hook and loop fastener or the like, where the flap can be opened to allow a user to reach through the door and operate the door latch. The door latch operating handle can be extended with a flexible pigtail, so it is easier to grasp and operate when a person reaches through the flap from the outside.

In one aspect a removable door for an SUV includes a rigid perimeter frame that carries two hinge pins on the front side that are configured to be engaged with door hinges of the SUV, and a door latch on the rear side that is configured to engage with a door latch of the SUV. An annular rim canvas is attached to (e.g., fits over) and covers at least most of the frame, with openings for the hinge pins and a zipper along its interior that defines a door opening. A flexible door insert has an external zipper that matches and is configured to be coupled to the rim canvas zipper, to removably close the door opening. The door insert includes a clear flexible window element. There is a closable flap in the door insert that is configured to be opened from outside the door to allow a person to reach through the door and operate the door latch, to allow the door to be opened from the outside.

In an example the hinge pins include stops that limit the insertion of the hinge pins into the door hinges of the SUV. In an example the flap is coupled/attached to the door insert in part by sewing. In an example the flap is coupled to the door insert in further part by a hook and loop fastener system.

In an example the removable door also includes removable supports for the door insert. In an example the removable supports for the door insert comprise at least one piece of support material that is coupled to the rim canvas and can be selectively coupled to the door insert. In an example the support material comprises webbing. In an example the support material can be coupled to the rim canvas in such a way that it can be pulled across the zipper and be coupled to the door insert. In an example the support material is configured to be coupled to the door insert by a snap. In an example the removable door has two removable door insert supports, one in the front and one in the rear, to support the door insert when it has been partially unzipped from the rim canvas at the top.

In an example the removable door also includes an elongated pocket attached to the inside of the door insert. In an example the removable door also includes a strip of solid material that is configured to removably fit into the elongated pocket, so that the door is more stable in high winds. In an example the strip of solid material comprises a batten.

In the illustrated examples vehicle V is an SUV with one or more removable doors that are replaced by the inventive door. Door 10 is shown on the Wrangler Sport 2005 (left side). Door 10 can be used as one or more of the front and rear driver and passenger side doors of an SUV with removable doors. Door frame 12 may be made from ⅜″ round bar stock or equivalent. Frame perimeter 14 is formed and hinges and latch are added to it, e.g., by welding. Hinges 20 and 30 include hinge pins made from ¾″ steel bar stock with a stainless steel washer w/¾″ inner hole that acts as a door stop. Optional side mirror holder 25 allows for optional side mirrors. Latch assembly 40 includes plate 40 that connects a standard door latch to the door frame.

Canvas rim 52 stays on the door when the insert is in use or when the insert is stowed away under seat or in trunk. Zipper half 1A 54 remains after the door insert is removed. The fully assembled door 60 (60a with optional batten) is shown.

The complete front door 10, outside of chassis. The two rear doors are also an option. The four door models on all SUVs are to be double sided so the finish side is to be on the outside of door as well as the inside. Option of color for fabric. Different colors/patterns.

Door insert 62 rolls up while not zippered into rim 52 and it conveniently fits into bag 140. Canvas part 63 can be made from Cordura nylon canvas or equivalent. Zipper 1B 64 connects to zipper half 54. Vinyl window 66 and latch access flap (i.e., “doggy door”) 70, and a flap 72 that covers the latch, are included. Snaps and webbing 82 and 84 provide extra support when needing to unzip window halfway and unclips while taking out the insert 62. There are two snaps, one on either side of the zipper located about halfway up the front zipper to take the weight of the top part of the window off of the zipper. Zippers are not meant to carry all the weight. *2 and 84 are made from a small piece of webbing. Snaps can be attached to the 3″ or 4″ webbing and can be removed for easy disassembly of door.

Honda Door Latch 100 and door latch/lock 106, hinge 108 and handle 110 are Honda branded parts. Handle extension 112 is made from paracord.

Optional horizontal support/pocket 120 creates door rigidity in the wind. Canvas pocket 124 is sewn to the door canvas. Opening 126 is where boat (sail) batten 128 removably fits. Sailboat style “batten” 128 slides into the sewn-on pocket through opening 126. This is ideally placed horizontally under the window and should fit in the bag. The batten takes the slack off the door, making it more stable in high winds on the road. Batten flap/pocket 130 is sized and shaped to hold batten 128 firmly in the pocket. Velcro 132 and 134 close 128 to 124 and connects 124 to 132.

Dry bag 140 is used for storage for the rolled-up door and can be made out of “Cordura” nylon, the same material as the doors. It is preferably a dry sack style with webbing on top with clips to secure/close the bag. In an example the color matches the door color.

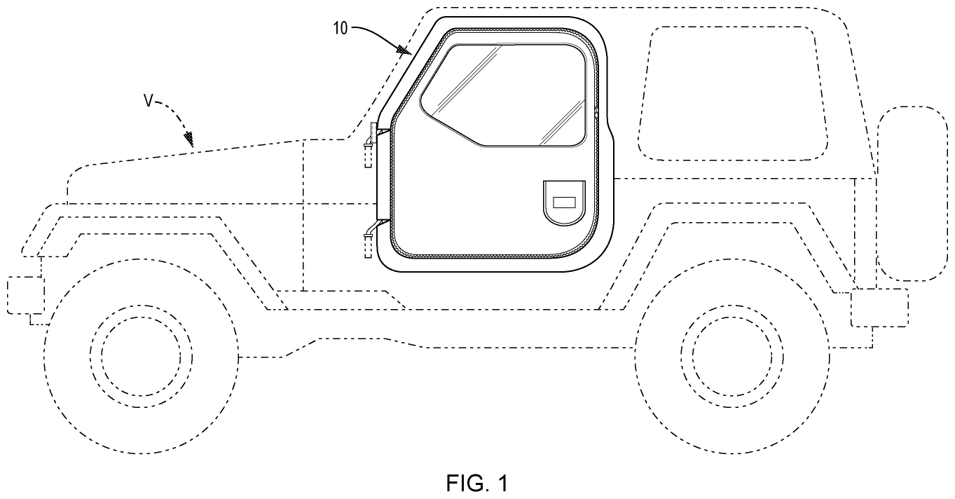

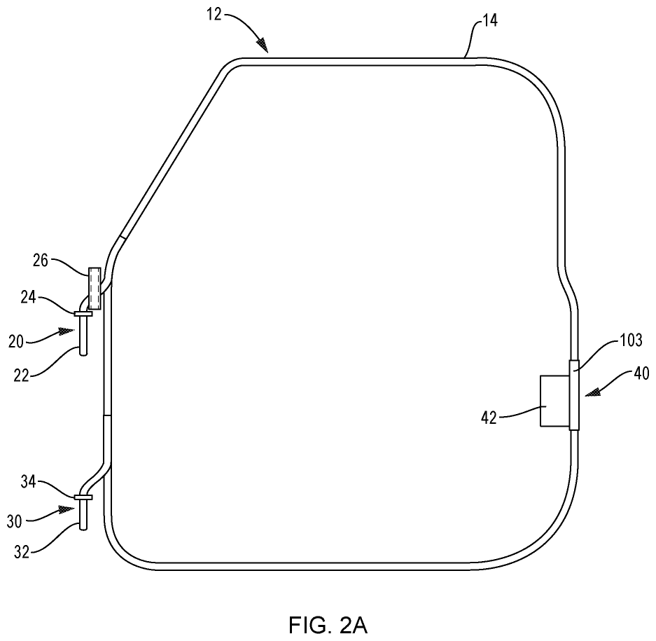

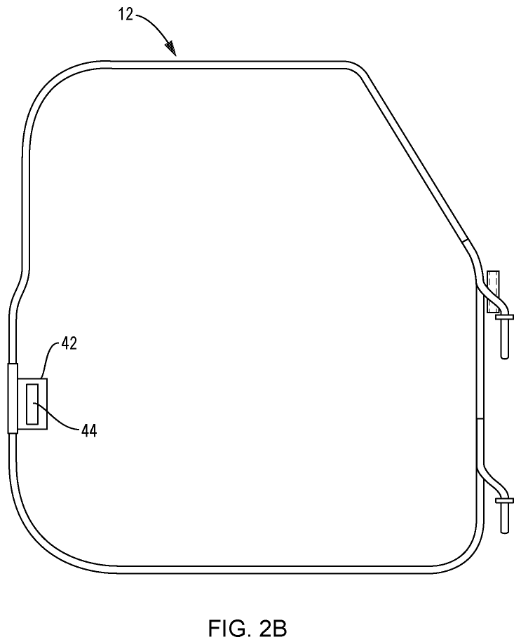

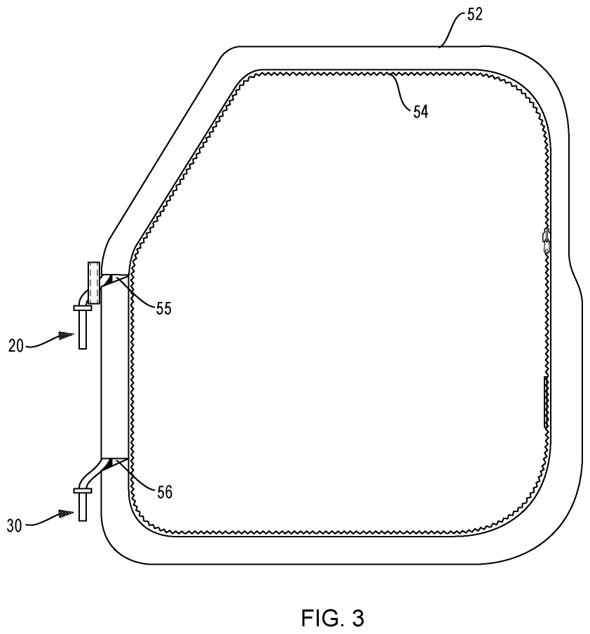

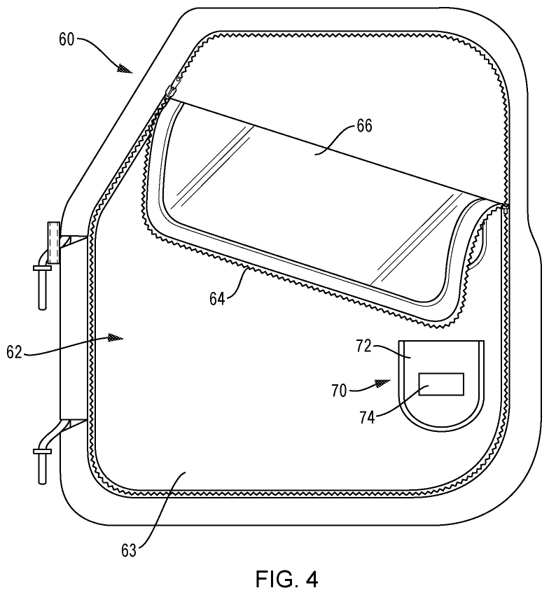

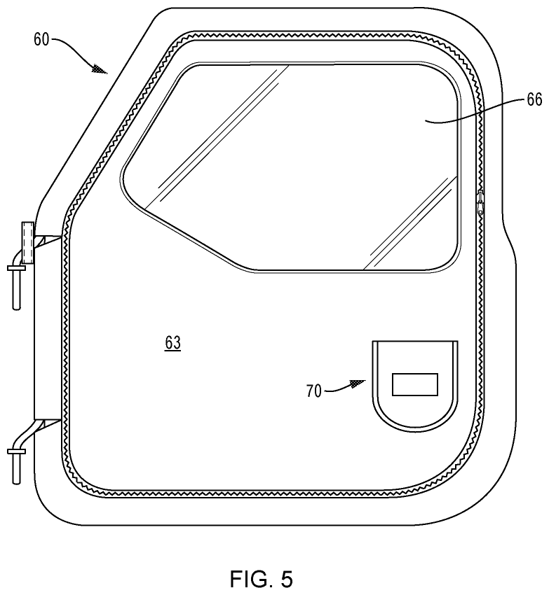

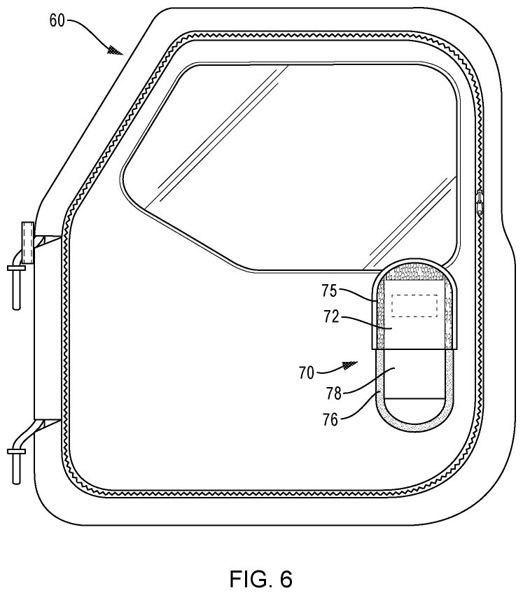

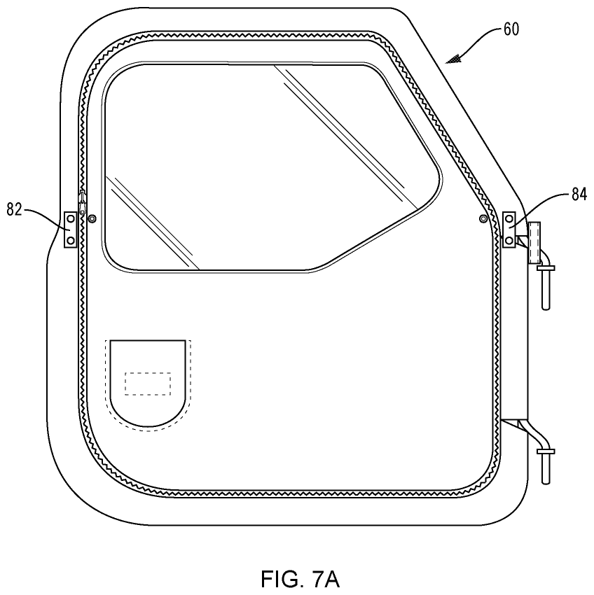

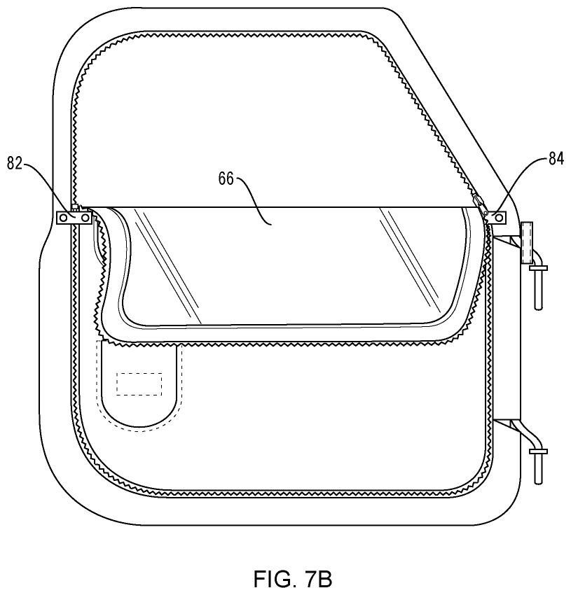

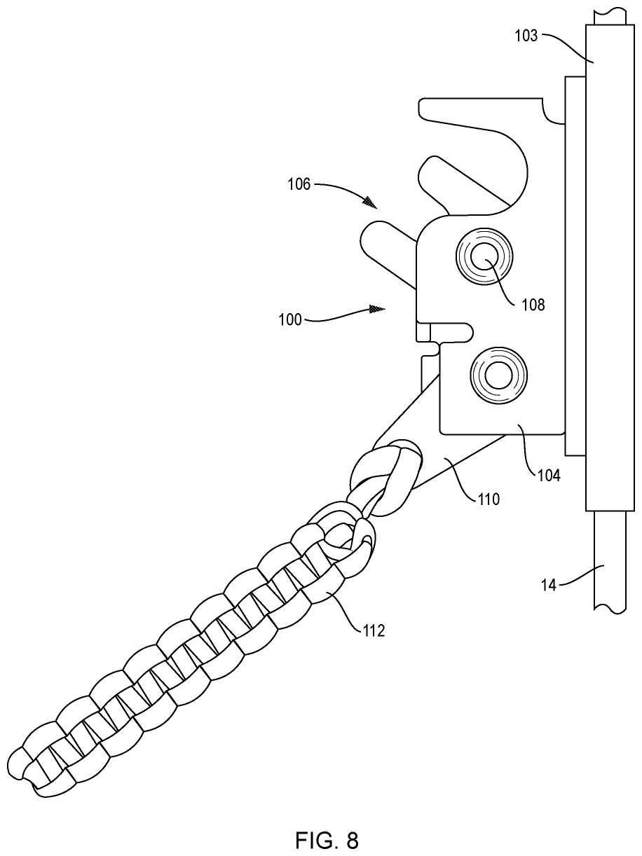

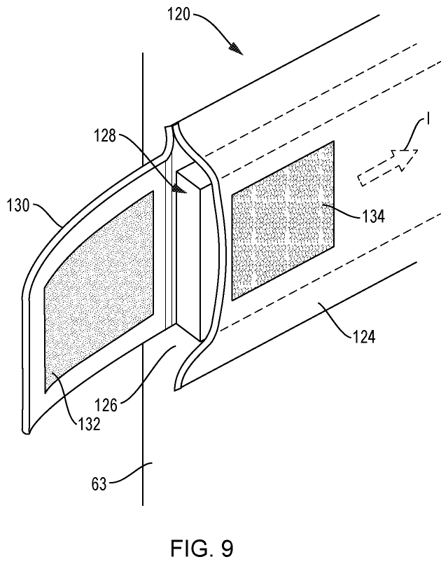

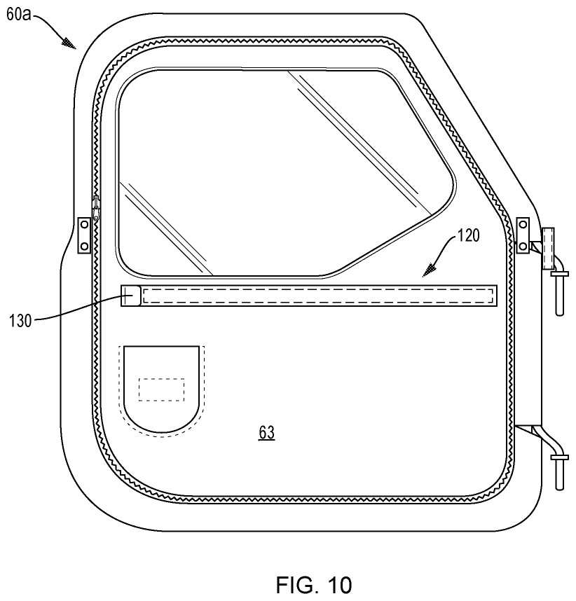

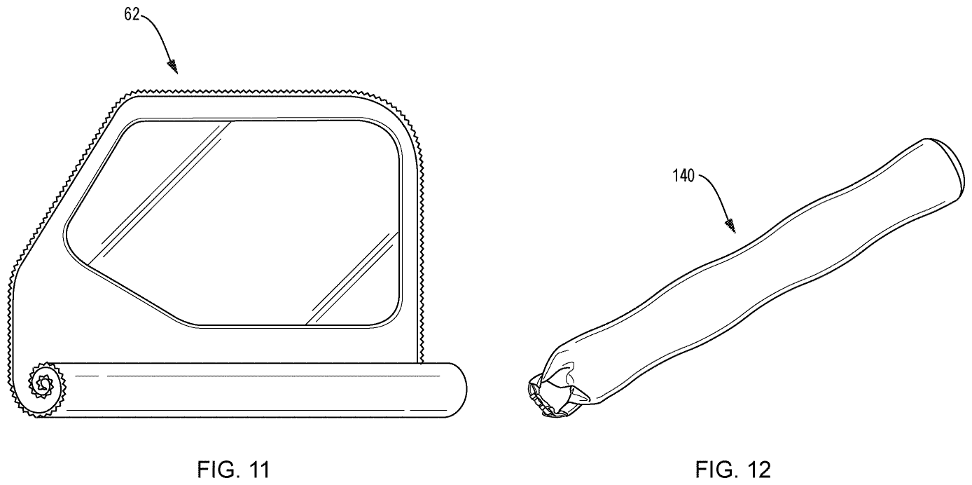

Following is a list of parts numbered in the enclosed FIGS. 1-12, which illustrate non-limiting examples of the inventive SUV door. The function of the part is also described. Other options and additions will become apparent once the invention and examples are explained and understood.

| Part list | | Function list |
|---|---|---|
| # | Title | Description |
| V | Vehicle | an SUV with one or more removable doors that are |
| | | replaced by the inventive door. |
| 10 | Overall driver side image of | What the Door looks like on the Wrangler Sport 2005 |
| | Portable Door/Removable, | (left side). Door 10 can be used as one or more of the |
| | compact door mounted to an | front and rear driver and passenger side doors of an |
| | SUV | SUV with removable doors. |
| 12 | Door Frame | Currently ⅜″ round bar stock. Could be ½″ square |
| | | tubing. |
| 14 | Door frame perimeter. Can | Frame is formed from this material, and hinges and |
| | be made from the door frame | latch are added to it, e.g., by welding. |
| | materials or from ¾″ steel | |
| | bar stock | |
| 20 | Top Male Hinge | Longer than “30” for convenient insertion |
| 22 | Hinge pin made from ¾″ | Longer pin for insertion into chassis hinge. |
| | steel bar stock | |
| 24 | Stainless steel washer w/ ¾″ | “Hinge stopper” Washers are welded to the “Pin” to |
| | inner hole | stop the door from sliding down too far into the |
| | | receiving chassis hinge. |
| 25 | Side Mirror Holder | Allows for optional side mirrors |
| 26 | ¾″ Steel Tubing | Female pipe. ⅜″ to match aftermarket mirrors. |
| 30 | Bottom Male Hinge | Same as “Upper Hinge” only for the bottom chassis |
| | | hinge. |
| 32 | Hinge pin made from ¾″ | |
| | steel bar stock | |
| 34 | Stainless steel washer w/ ¾″ | “Hinge stopper” Washers are welded to the “Pin” to |
| | inner hole | stop the door from sliding down too far. |
| 40 | Latch assembly | FIG. 8 illustrates a specific example of a latch assembly. |
| 42 | Plate | Supports and connects the “Door Latch” to the door |
| | | frame 12 |
| 103 | ¾″ Stainless Tubing | Fits over frame material 14 to connect plate 42 (and thus |
| | | latch 44 carried by plate 42) to frame material 14 |
| 44 | Door Latch | Honda Part. See FIG. 8 for detail. |
| 52 | Canvas Rim | Canvas rim of door. Stays on the Door when the insert |
| | | is in use or when the insert is stowed away under seat or |
| | | in trunk. |
| 54 | Zipper 1A | This ½ of zipper remains after door insert is removed |
| 55 | Top Gap in the #52 | Allows for the #20 to protrude out of the #52 |
| 56 | Bottom Gap in the #52 | Allows for #30 to protrude out of canvas rim 52 |
| 60 | Fully assembled door | 12″ #8 coil zipper (can be closer to the frame of the |
| | | door) makes the door fabric more streamlined. Non |
| | | zinc/Lycra. UV Protectant. |
| 60a | Fully assembled door with | |
| | the optional additional | |
| | batten. | |
| 61 | Door Description | Complete Front door, outside of chassis. 2 rear doors are |
| | | also an option for any 4 door model of SUV with |
| | | removable doors. The 4 door models from TJU - JLU |
| | | Suitable fabric to be double sided so the finish |
| | | side is to be on the outside of door as well as the |
| | | inside. |
| | | Option of color for fabric. Different colors/patterns. |
| 62 | “Door” Insert | See FIG. 11. Rolls up while not Zippered into #52. |
| | | Conveniently fits into #140 |
| 63 | Canvas part of Door Insert | Cordura nylon canvas or suitable material |
| 64 | Zipper 1B | Connects to 54 |
| 66 | Vinyl Window | UV protectant and sewable |
| 70 | Doggy Door | Convenient flap that allows coverage of latch. |
| 72 | Canvas Flap | Top is sewn and other 3 sides are velcroed to #63 |
| 74 | Marketing Logo | Branding spot |
| 75 | Velcro - 1A | “Hook” side of Velcro |
| 76 | Velcro - 1B | “Loop” side of Velcro |
| 78 | Access flap to latch #44 | Cut into the door allows for entry into vehicle |
| 82 | Snap and Webbing/Back | Provides extra support when needing to unzip window |
| | | ½ way. Unclips while taking out the #62. |
| | | 2 snaps on either side of zipper. Halfway up the front |
| | | zipper to take the weight of the top ½ of window off the |
| | | zipper. Zippers are not meant to carry all the weight. |
| | | Small piece of webbing. Snaps can be attached to the 3″ |
| | | or 4″ webbing and can be removed for easy disassembly |
| | | of door. |
| 84 | Snap and Webbing/Front | Same as #82 |
| 100 | Example: Honda Door Latch | Example: Honda Brand |
| 106 | Example: Honda Door | Example: Honda Brand |
| | Latch/Lock | |
| 108 | Example: Honda Door | Example: Honda Brand |
| | Latch/Hinge | |
| 110 | Example: Honda Door | Example: Honda Brand |
| | Latch/Handle | |
| 112 | 110/Handle Extension | Paracord Handle |
| 120 | Optional Horizontal Support/ | Creates Rigidity in Wind |
| | Pocket | |
| 124 | Canvas Pocket | Sewn to door canvas |
| 126 | Opening | Opening into space where batten 128 fits |
| 128 | Boat Batten | Sailboat style “batten” slides into the sewn-on pocket |
| | | through opening 126. Placed horizontally under the |
| | | window. Must fit in the bag. Takes the slack off the |
| | | door making it more stable in high winds on the road. |
| 130 | Batten Flap/Pocket | Holds batten #128 firmly into the pocket |
| 132 | Velcro | Sewn to #130 to close #128 into #124 |
| 134 | Velcro | Sewn to #124 to connect to #132 |
| 140 | Dry Bag | Storage for rolled up door insert 62. Made out of |
| | | “Cordura” nylon for example, or equivalent material. |
| | | Same material as the doors. Dry sack style with |
| | | webbing on top. Clips to secure/close bag. Color |
| | | matches the door color. |

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A removable door for a sport utility vehicle (SUV) comprising:
a rigid perimeter frame that carries two hinge pins on the front side that are configured to be engaged with door hinges of the SUV, and a door latch on the rear side that is configured to engage with a door latch of the SUV;
an annular rim canvas that is configured to be attached to at least most of the frame, with openings for the hinge pins, and a zipper along its interior that defines a door opening;
a flexible door insert with an external zipper that matches and is configured to be coupled to the rim canvas zipper, to removably close the door opening, wherein the door insert includes a clear flexible window element; and
a closable flap in the door insert that is configured to be opened from outside the door to allow a person to reach through the door and operate the door latch, to allow the door to be opened from the outside.

2. The removable door of claim 1 wherein the hinge pins include stops that limit the insertion of the hinge pins into the door hinges of the SUV.

3. The removable door of claim 1 wherein the flap is coupled to the door insert in part by sewing.

4. The removable door of claim 3 wherein the flap is coupled to the door insert in further part by a hook and loop fastener system.

5. The removable door of claim 1 further comprising removable supports for the door insert.

6. The removable door of claim 5 wherein the removable supports for the door insert comprises at least one piece of support material that is coupled to the rim canvas and can be selectively coupled to the door insert.

7. The removable door of claim 6 wherein the support material comprises webbing.

8. The removable door of claim 6 wherein the support material is coupled to the rim canvas in such a way that it can be pulled across the zipper and be coupled to the door insert.

9. The removable door of claim 8 wherein the support material is configured to be coupled to the door insert by a snap.

10. The removable door of claim 9 comprising two removable door insert supports, one in the front and one in the rear, to support the door insert when it has been partially unzipped from the rim canvas at the top.

11. The removable door of claim 1 further comprising an elongated pocket attached to the inside of the door insert.

12. The removable door of claim 11 further comprising a strip of solid material that is configured to removably fit into the elongated pocket, so that the door is more stable in high winds.

13. The removable door of claim 12 wherein the strip of solid material comprises a batten.

14. A removable door for a sport utility vehicle (SUV) comprising:
a rigid perimeter frame that carries two hinge pins on the front side that are configured to be engaged with door hinges of the SUV, and a door latch on the rear side that is configured to engage with a door latch of the SUV, wherein the hinge pins include stops that limit the insertion of the hinge pins into the door hinges of the SUV;
an annular rim canvas that is configured to fit over and cover at least most of the frame, with openings for the hinge pins, and a zipper along its interior that defines a door opening;
a flexible door insert with an external zipper that matches and is configured to be coupled to the rim canvas zipper, to removably close the door opening, wherein the door insert includes a clear flexible window element;
a closable flap in the door insert that is configured to be opened from outside the door to allow a person to reach through the door and operate the door latch, to allow the door to be opened from the outside, wherein the flap is coupled to the door insert in part by sewing and wherein the flap is coupled to the door insert in further part by a hook and loop fastener system;
two removable supports for the door insert that each comprise webbing that is coupled to the rim canvas in such a way that it can be pulled across the zipper and be coupled to the door insert and is configured to be selectively coupled to the door insert by a snap, wherein the two removable door insert supports are located one in the front and one in the rear, to support the door insert when it has been partially unzipped from the rim canvas at the top; and
an elongated pocket attached to the inside of the door insert, and a batten that is configured to removably fit into the elongated pocket so that the door is more stable in high winds.
